(19) United States
(12) Patent Application Publication
(10) Pub. No.: US 2020/0244896 A1
(43) Pub. Date: Jul. 30, 2020

(54) Tablet with camera's

(71) Applicant: Gregory Walker Johnson, Dayton, OH (US)

(72) Inventor: Gregory Walker Johnson, Dayton, OH (US)

(21) Appl. No.: 16/873,269

(22) Filed: Mar. 10, 2020

Related U.S. Application Data
(63) Continuation-in-part of application No. 15/999,162, filed on Aug. 17, 2018.

(51) Int. Cl. H04N 5/247; H04N 5/225; G06F 1/16

(52) U.S. Cl. CPC H04N 5/247; G06F 1/1626; H04N 5/2257

(57) ABSTRACT

A tablet with a front and rear facing camera that is executed by software stored in the tablet.

### BRIEF DESCRIPTION OF THE DEVICE

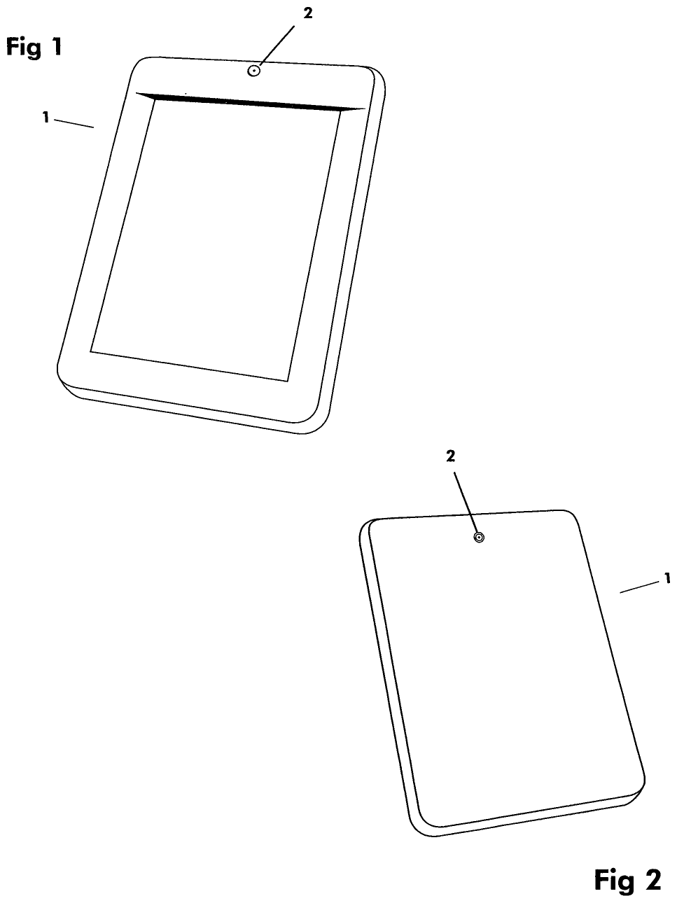

FIG. 1 Shows front of tablet with camera

FIG. 2 Shows back view of tablet with camera

### DETAIL DESCRIPTION OF THE DEVICE

FIG. 1 Shows front of tablet 1, with camera 2.

FIG. 2 Shows back view of tablet 1, with camera 2.

### SUMMARY OF THE INVENTION

The Tablet is very basic with front and rear facing camera's and is executed by Software stored in the Tablet.

What is claimed is:

1. A Portable Tablet Device Comprising:
1. a first camera positioned on a front face of the tablet;
a second camera positioned on a rear face of the tablet;
That is executed by software.
